(19) United States
(12) Patent Application Publication
(10) Pub. No.: US 2025/0290578 A1
(43) Pub. Date: Sep. 18, 2025

(54) PIPE-SUPPORT

(71) Applicant: AIRBUS OPERATIONS LIMITED, Bristol (GB)

(72) Inventors: Nicholas WEST, Bristol (GB); Stuart WHITTAKER, Bristol (GB)

(21) Appl. No.: 19/080,339

(22) Filed: Mar. 14, 2025

(30) Foreign Application Priority Data
Mar. 18, 2024 (GB) 2403871.3

(51) Int. Cl. F16L 5/00; B64D 37/00; B64D 37/30

(52) U.S. Cl. CPC F16L 5/00; B64D 37/005; B64D 37/30

(57) ABSTRACT

A pipe support assembly (114), suitable for supporting pipework handling cryogenic fluids, where the pipework passes through a fuel tank support. The pipe support assembly includes first and second pipe supports (116) each having male (119) and female (152) portions that interlock with male (119) and female (152) portions of the other pipe support (116). The pipe supports (116) have an internal surface (121) that contacts a section of the pipe outer surface (112). Each pipe support (116) has a split (140) which allows for a change in dimension of the internal surface (121) of the pipe support (116) contacting the pipe (110). This allows the pipe support assembly (114) to provide a consistent clamping force to the pipe (110) during thermal contraction or expansion. Longitudinal movement of the pipe (110) is permitted if the pipe (110) overcomes the frictional force between itself and the pipe support assembly (114).

### RELATED APPLICATION

This application incorporates by reference and claims priority to United Kingdom patent application GB 2403871.3, filed Mar. 18, 2024.

### BACKGROUND

The present disclosure relates to supporting a pipe. More particularly, but not exclusively, this invention concerns supporting a pipe in cryogenic applications, for example supporting a pipe carrying liquid hydrogen as a fuel in an aircraft.

Hydrogen has been identified as a potentially environmentally preferable alternative to traditional fossil fuels, such as kerosene, in use as a fuel source for aircraft.

Some aviation technologies and operations may require relatively minor adjustments to utilise hydrogen, whereas some will require more significant alterations. The fuel supply and storage system is one of the latter, due to the considerably different requirements and characteristics of hydrogen in comparison to traditional jet fuels.

In use, fuel travels between locations such as the fuel tanks and engines via pipework within an aircraft. Traditionally, the lengths of pipe are sufficiently long that they need to be supported at intervals, for example by brackets welded or fastened to both local structure(s) of the aircraft and to the pipe.

Use of cryogenic fluids, such as hydrogen, in these pipes introduces several complications. Cryogenic fluids need to be stored at low temperatures and/or at high pressures. The parts of an aircraft that are subjected to the low temperatures (and/or potentially high pressures) necessary for carrying/storing liquid hydrogen may also be required to reach ambient temperature (and/or atmospheric pressure), for example, during maintenance and/or between periods of operation of the aircraft. There may therefore be a need for such parts of the aircraft to be able to cope with both very low temperatures and also large changes in temperature. Changes in temperature can cause thermal expansion and/or contraction of materials, and this can be a particularly significant issue when considering cryogenic applications.

Thermal expansion and contraction is a change in dimensions of an object due to a change in temperature of the object. A larger change in temperature will cause a larger change in dimensions. Therefore, cryogenic fluids will have a greater effect on thermal expansion and contraction of pipework than fuels such as kerosene, which can be stored much closer to ambient temperatures.

Fuel pipes in an aircraft that are made of relatively rigid material (e.g. of metal) may also need to be securely fastened to local structure(s) to prevent excessive movement or vibration in use of the vehicle that might otherwise lead to fatigue loading on the pipe. As mentioned above, there will typically be at least one location, and more often multiple locations, at which the pipe is fixed to adjacent structure, whether by brackets welded to local structure, local fasteners or otherwise. Such fixed points of connection typically constrain movement of the pipework at each fixed point, in all degrees of freedom. During major temperature changes, excessive loads may be induced as a result of expanding/contracting lengths of pipework between such fixed points. This can risk damage to the welds, fasteners, and/or pipework, and/or reduce their operational lifetime, resulting in higher maintenance costs and/or higher risks of leaks of cryogenic fluid.

There is a desire to minimise the risk of fuel leaks in relation to jet fuels, and the same applies in relation to hydrogen as a fuel. Managing the risk of hydrogen leaks involves special considerations, however, given that hydrogen has a low ignition energy in comparison to traditional jet fuels, and has a wide range of flammability concentrations. Furthermore, hydrogen as a fuel has greater capacity to escape than conventional jet fuels due to its considerably lower boiling point, and also is likely to escape at higher flow rates if a leak does occur.

The present invention seeks to mitigate one or more of the above-mentioned problems. Alternatively or additionally, the present invention seeks to provide an improved pipe support.

### SUMMARY OF THE INVENTION

The present invention provides, according to a first aspect, a pipe support assembly for supporting a pipe in a cryogenic application. The pipe support assembly comprises a plurality of pipe supports. It may be that each pipe support comprises an opening for receiving a pipe. The opening may partially surround the pipe in use. The pipe support assembly may have an opening configured to hold the pipe in position in use. The opening may not be sized or designed to prevent longitudinal movement of the pipe to be received in the opening relative to the opening. The pipe supports are arranged to interlock with each other along a common longitudinal axis, to secure them to each other. Such a longitudinal axis may, in use, be parallel to (e.g. the same as) the longitudinal axis of the pipe. The pipe supports may be arranged longitudinally along the pipe. The pipe supports are configured to interlock with each other also to secure them relative to a portion of structure, for example with a first of the pipe supports on one side of the portion of structure and with a second of the pipe supports on an opposite side of the portion of structure. In embodiments, there may thus be provided a multi-piece pipe support that does not need to be welded to local structure and does not need to act as a rigid fixed location between pipe and pipe support, but nevertheless supports the pipe relative to the local portion of structure, thus allowing for the type of expansion and contraction of materials that are common in cryogenic applications.

In use and when the pipe support pipe supports are interlocked with each other to support a pipe, the pipe may be gripped by the pipe support with a force that permits movement of the pipe along its longitudinal axis only when a force exerted by the pipe on the pipe support along the longitudinal axis exceeds a threshold force. The threshold force may be a force that is 10N or more. The threshold force may be a force that is less than 500N, for example being in the range of 10N to 150N. The threshold force may be a targeted design feature of the pipe support.

In use, the pipe support supports a pipe that is configured to transport cryogenic fluids, for example liquid hydrogen. The pipe may have appropriate modifications for such an application and may, for example, include insulation. The pipe may have an outer diameter of at least 5 mm, for example at least 25 mm, for example at least 50 mm. The inner diameter of the pipe may be less than 100 mm.

The portion of structure that is secured relative to the pipe support assembly may be located between first and second pipe supports. The portion of structure may be in the form of a wall having a face on one side that faces the first pipe support and a face on the opposite side that faces the second pipe support. The wall may have an open region (for example a hole, optionally a slotted hole to allow for expansion/contraction of the hole) through which the pipe passes.

The plurality of pipe supports of the pipe support may be configured to restrain (and/or constrain) movement of a pipe radially. The plurality of pipe supports forming the pipe support assembly may be configured to restrain (and/or constrain) movement of a pipe longitudinally. (The radial and longitudinal directions are defined with reference to the axis of the pipe locally.) It will be understood that the manner by which the pipe support restrains movement of the pipe does not prevent any movement of the pipe relative to the pipe support assembly throughout all aspects of operation during which the pipe is held by the pipe support assembly. The plurality of pipe supports may be configured to hold the pipe while permitting movement of the pipe longitudinally relative to the pipe support. The plurality of pipe supports may be configured such that, in use, the pipe support assembly provides a clamping force on the pipe which can be pre-determined. The clamping force may be such that movement of the pipe along its longitudinal axis is restricted, but not altogether prevented, by friction. It may be the case that if the pipe exerts a greater force than the frictional retaining force, owing to thermal expansion or contraction for example, the pipe is permitted to move relative to the pipe support, reducing the risk of damage to the pipe or the portion of structure to which the pipe support is secured, or to associated structural components, and thus reducing the risk of leaks.

Each pipe support may be made from a material, for example a polymer material, configured for cryogenic application. Each pipe support may made from a thermoplastic material. Each pipe support may be made from a thermoplastic poly(haloethylene), such as a poly(tetrahaloethylene), such as poly(chlorotrifluoroethylene), also known as PCTFE. Each pipe support may be made from poly aryl ether ketone, often known as PAEK. Examples of PAEK materials include poly ether ether ketone (PEEK) and poly ether ketone ketone (PEKK). Use of a material as mentioned above may provide each pipe support, and by extension the pipe support, with good thermal stability. This may mean that the pipe support displays consistent physical characteristics over a large temperature range, for example in a range from typical ambient conditions down to 40K or lower, for example around 20K.

Each pipe support may be defined by a single-piece component. It may be that the number of pipe supports forming the pipe support assembly is two. The two pipe supports may be identical in size and dimensions. This may streamline manufacture. This may assist with mass production. This may assist with ease of installation. It will be appreciated that there will naturally be minor differences between two identically machined parts owing to inevitable inaccuracies inherent within any manufacturing process, but these differences are negligible in practice and would not prevent such parts as nevertheless being considered as identical parts. The two pipe supports may, when interlocked with each other, be orientated inversely to the other. The orientation of the first pipe support may for example be such that its shape may be mapped onto the shape of the second pipe support by being rotated, relative to the second pipe support, by 180° about an axis perpendicular to the longitudinal axis (and optionally by then being rotated about the longitudinal axis, relative to the first pipe support).

Each pipe support may be in the form of a grommet.

Each pipe support may comprise a body, for example a main body portion. The body of a pipe support may be substantially cylindrical. The body of a pipe support may be a hollow cylinder. The body of a pipe support may comprise an outer surface. The outer surface may be an externally facing surface defining the outside of the pipe support. The cross section of the outer surface of the body may be circular. The outer surface may be filleted at one end. The outer surface may be filleted at an edge between the outer surface and a rear surface of the body. The rear surface of the body may be a face of a hollow cylinder. The rear surface may be the trailing face when the pipe support is positioned on a pipe (i.e. the two opposite distal surfaces of the pipe support assembly being formed by a rear surface of a first pipe support and by a rear surface of a second pipe support).

As stated above each pipe support has an opening for receiving a pipe. The opening may be defined by a circumferentially extending inner surface of the pipe support. Each opening of each pipe support may thus have an inner diameter sized similarly to the outer diameter of the pipe to be secured in the opening. Each pipe support may have a split (as discussed further below) to accommodate expansion/contraction of the opening. The cross-section of the inner surface of the body may be constant. The cross-section of the inner surface may be a broken circle (for example providing a split). The cross-section of the inner surface may be a broken circle broken with indents. The inner surface may be formed of alternating arcuate surfaces and indents. The arcuate surfaces may define sectors of the broken circle.

Each pipe support may comprise a protrusion used to locate the pipe support relative to the portion of structure, for example when the portion of structure has a hole within which the pipe is accommodated. This protrusion (i.e. the locating protrusion) may be a locating spigot. The locating protrusion may comprise a cylindrical formation and/or the protrusion may comprise multiple formations arranged in a ring. The locating protrusion may extend from a face of the body. The locating protrusion may extend from a front surface of the (above-mentioned) body of the pipe support (the front surface of the body being the face of the body opposite to its rear face). The locating protrusion may be substantially cylindrical. The locating protrusion may be a hollow cylinder. The locating protrusion may have an outer surface. The outer surface may be cylindrical. The diameter of the cross section of the outer surface of the locating protrusion may be less than the diameter of the cross section of the outer surface of the pipe support body. The locating protrusion may have an inner surface. The locating protrusion inner surface may have the same cross section as the pipe support body inner surface. The pipe support body may share its inner surface with the locating protrusion. The locating protrusion may be a hollow cylindrical form (for example an extrusion) extending from the front surface of the body, with a reduced external diameter. The locating protrusion may extend a shorter distance from the body than the longitudinal length of the body. The locating protrusion may have a front surface. The locating protrusion front surface may be at the opposite end of the protrusion to the junction between the locating protrusion and the front surface of the body. The locating protrusion front surface may be a front surface of the pipe support.

Each pipe support may have a sector with a region configured to accommodate expansion and contraction of the pipe support around a pipe. Such a region may be part of the (main) body of the pipe support. The region may be contained within a sector of the pipe support (i.e. a portion extending circumferentially between two angularly spaced apart positions around the pipe support) around the pipe, which may for example be wedge-shaped. In cross-section, a sector of a pipe support may have the general shape of an arcuate portion of a circle. The region may comprise a split (e.g. a gap defined by a split ring feature).

The region (for accommodating expansion and contraction) may extend at least partway across the longitudinal length of the body, for example the whole longitudinal length of the body. The region may extend at least partway across the longitudinal length of the locating protrusion (if present), for example the whole longitudinal length of the locating protrusion. The region may extend from a rear surface of the pipe support to a front surface of the pipe support. The front surface to which the region extends may be the front surface of the body. The front surface to which the region extends may be the front surface of the locating protrusion. The region may extend at least partially through the radial thickness of the body, for example through the entire radial thickness of the body, and in that example may thus be a split. The region may extend at least partially through the radial thickness of the locating protrusion, for example through the entire radial thickness of the locating protrusion, and in that example may thus be a split. The region may extend from an inner surface of the pipe support to an outer surface of the pipe support. In the case where there is both such a region associated with the locating protrusion and such a region associated with the body, there may be one continuous region (i.e. across both the locating protrusion and the main body). The region may be at least 0.5° in angular thickness (i.e. the angular extent of the region/split around e.g. the circumference of the pipe support assembly), for example about 1° or more, and optionally at least 2°. It may be that the angular extent of the region is 10° or less, and optionally about 5° or less. The region may have constant cross section along its length (in the longitudinal direction), for example along the majority of its length, and preferably along substantially its entire length. The region may allow a change in diameter of the inside surface of the body. This may allow the internal diameter of the pipe support to adjust relative to the changes in the outer diameter of a pipe, which may have a different coefficient of thermal expansion (CTE) to the pipe support, for example during large changes in temperature of the pipe and pipe support. For example, the pipe support may be made of a material with a substantially lower CTE than the pipe, which may cause the pipe to shrink away from, and thus lose contact with, the pipe support during cooling, if not for the region permitting the pipe support to change size in accordance with the pipe, thus keeping it in contact and supported. This may allow the pipe support to provide a compressive force on the pipe that is consistently within an appropriate range. This may allow the pipe support to provide a targeted compressive force on the pipe in cryogenic conditions. The changing diameter of the inner surface afforded by the region may ease assembly.

The pipe support may have plurality of male and female locking portions, wherein the male portions are configured to interlock with the female portions of a corresponding pipe support. A male portion may be an extending protrusion. A female portion may be a receiving indentation. The male portions may be in the form of teeth. The female portions may be provided by indents in the inner surface. The indents may protrude into the pipe support, i.e. from the inner surface towards the outer surface. The indents may be arranged uniformly around in the circumferential direction. There may be at least 2 indents, for example at least 4 indents, for example at least 6 indents. The indents may be configured to receive teeth of another pipe support. The indents may run the longitudinal length of the inner surface of the pipe support pipe support.

The number of teeth may correspond to the number of indents in the inner surface of the pipe support body. There may be at least 2 teeth, for example at least 4 teeth, for example at least 6 teeth.

Each tooth may be identically shaped. Each tooth may comprise a base at one end and a head at the other, and may extend from a face of the body and/or of the locating protrusion of the pipe support, for example extending from a face of the locating protrusion, if present. The tooth may extend parallel to the length of the pipe support body (i.e. along the longitudinal direction). The teeth may be arranged uniformly concentrically around the central axis of the pipe support. The head of each tooth may comprise a ridge, that in use engages with a wall of an indent in order to provide the interlocking between the pipe supports. The ridge may be dimensioned so that it extends further from the central axis of the pipe support than the indents of the inner surface. The teeth may be configured to flex in use to allow the pipe supports to be pushed together. The teeth may be configured such that when the pipe supports are locked together, the head of each tooth is resiliently urged towards the locked position and/or provides a resilient force which resists against movement away from the locked position. The longitudinal distance from the base to the ridge of each tooth may be at least as long as the distance from the rear surface of the pipe support to the front surface of the locating protrusion.

According to a further aspect of the invention there is provided a method of supporting pipework positioned at least partially through a portion of structure in a cryogenic application. The method may comprise using the above-described pipe support assembly.

The method may comprise a step of installing a first pipe support on a pipe. A portion of the outside surface of the pipe may be flush with the innermost portions of the inner surface of the first pipe support. There may be gaps between the pipe and the inner surface of the first pipe support (for example when indents are provided). The method may comprise a step of interlocking a second pipe support with the first pipe support. The second pipe support is disposed relative to the first pipe support along the pipework's longitudinal axis. Once interlocked, the first and second pipe supports form a pipe support assembly located in the region where the pipe is positioned through the portion of structure. The pipe supports may be positioned on opposite sides of the portion of structure.

The above steps of installing and interlocking may be carried out at ambient conditions. These may be the conditions currently present in the location where the steps are taking place. This may ease installation. The method may further comprise locating at least one of the pipe supports within a hole in the portion of structure. This may be a hole through which the pipe passes. This may constrain radial movement of the pipe support, and in turn of the pipe. This may prevent damage to the pipe support or surrounding structure. The pipe may be free to move longitudinally relative to the first and second pipe supports, with the application of a sufficient longitudinal force, for example to accommodate contraction/expansion of the pipe during use.

When installing a pipe support on the pipework this may comprise orienting the first pipe support so that an internal cross section of the pipe support is aligned with (e.g. coincident with) the axis of the pipe.

The method may further comprise adjusting an internal dimension of the first pipe support. This may comprise manually elastically deforming the first pipe support. The step may comprise, while the first pipe support is elastically deformed and oriented correctly, moving the first pipe support onto the pipe. The step may further comprise moving the first pipe support to the desired location on the pipe. The step may also comprise allowing the first pipe support to elastically undeform to its original configuration. This part of the step may be done at any time after the first pipe support is on the pipe. This may cause the first pipe support to exert a clamping force on the pipe.

The method may further comprise a step of passing the pipe through a portion of structure. The portion of structure may be a piece of support structure in a fuel-tank. There may be a hole in the portion of structure through which the pipe can pass. The hole in the structure may be larger than the outside diameter of the pipe. The pipe may be positioned through the hole in the desired location for operation of the pipe. The pipe may be positioned through the hole with the first pipe support already attached. Alternatively, the pipe may be passed through the hole first, and the first pipe support installed after.

The method may further comprise the step of locating a pipe support against the hole, for example, so that the pipe support locates against and within the structure defining the hole. The first pipe support may have a locating protrusion which locates within the hole. The outer surface of the locating protrusion may be flush with a surface defining the hole. This may constrain movement of the first pipe support in all radial directions (e.g. directions perpendicular to the longitudinal axis of the pipe), relative to the portion of structure), thus either permitting no movement or only movements small enough so that they do not damage or displace any other components. The first pipe support may have a first front surface which contacts the portion of structure. The first front surface of the first pipe support may be flush with the portion of structure. This may prevent further movement of the first pipe support in the longitudinal direction relative to the portion of structure.

The method may further comprise the step of positioning a second pipe support on the pipe. This step may comprise repeating the previous steps for positioning the first pipe support on the pipe only for the second pipe support, for example orienting the second pipe support, adjusting an internal dimension of the second pipe support, pushing the second pipe support onto the pipe, and allowing the second pipe support to elastically undeform. The step may further comprise moving the second pipe support to the point where it interlocks with the first (e.g. when teeth of one pipe support are longitudinally adjacent to teeth of the other pipe support).

The method may further comprise the step of further orientating the first or second pipe support so that they are positioned for interlocking. This may further comprise rotating one pipe support relative to the other about the longitudinal axis. In an embodiment where teeth and indents are provided for the interlocking, this may be done until the teeth of the first pipe support line up with gaps defined by the indents in the internal surface of the second pipe support, such that each tooth has the same angular position about the longitudinal axis as a respective gap.

The method may further comprise the step of interlocking the pipe supports together. This may comprise male portions of the first pipe support interlocking with female portions of the second pipe support concomitantly with male portions of the second pipe support interlocking with female portions of the first pipe support. This step may further comprise bracing the first pipe support from the rear. This step may further comprise moving (e.g. pushing) the second pipe support towards the first pipe support.

The interlocking of the pipe supports together may further comprise the teeth of the second pipe support entering gaps (e.g. defined by indents) of the first pipe support. This may also comprise the teeth of the first pipe support entering the gaps of the second pipe support. The teeth of the first pipe support may enter the gaps of the second pipe support simultaneously as the teeth of the second pipe support enter the gaps of the first pipe support. The teeth may elastically deform inwardly during passage through the gaps. The teeth may bend such that a base of each tooth is unmoved, and the head of each tooth is deflected towards the longitudinal axis of the pipe. The step may further comprise urging the two pipe supports towards each other until the heads of the teeth of each pipe support exit the gaps at the rear surface of the other each pipe support. This may comprise each tooth undeforming back to its undeflected position. This may occur because the teeth (e.g. the heads of the teeth) are no longer constrained by the gaps. A portion of each tooth head (e.g. a ridge) may overhang the gaps at the rear surface, for example having a surface that is flush with the rear surface of the corresponding pipe support. This may prevent movement of the pipe support in the reverse direction. This may occur with all teeth concurrently. This may lock each pipe support in place relative to the other pipe support, and may also fix the position of the pipe support relative to the portion of structure. It may also be that the pipe supports constrain longitudinal motion of the pipe relative to the portion of structure. In use, the first and second pipe supports may be positioned either side of the portion of structure, which is thus sandwiched between the two pipe supports.

The locating protrusion of the second pipe support may locate in the hole in the portion of structure. This may occur in the same way as the first pipe support. This may happen concurrently with the interlocking of the first and second pipe supports.

According to a yet further aspect of the invention there is provided a method of operating a pipe support according to the present invention as described or claimed herein as part of a cryogenic application. In this method, cryogenic fluid is passed through the pipe. The pipe may be a rigid pipe. The pipe may be a metal pipe, optionally an insulated metal pipe. The pipe may have a portion that is fixed in location, and designed not to move relative to local surrounding structure in use. It may be that longitudinal movement of the pipe relative to the pipe support is permitted when the pipe exerts a force greater than a threshold force on the pipe support, for example owing to thermal expansion or contraction. This can provide protection against excessive stresses being that might otherwise be incurred as a result of rigid fixings along the length of the pipe.

The threshold force may be a force between 10N and 500N in a longitudinal direction, for example between 20N and 150N, for example between 20N and 120N, for example about 60N.

The cryogenic fluid may be liquid hydrogen. During use, the temperature of the pipe may reduce to a temperature of 40K or below, for example 30K or below, for example around 20K. Each pipe support may contract as cryogenic fluid is passed through the pipe. Contraction of each of the first and second pipe supports on the pipe may be accommodated by a region within a sector of each pipe support.

According to a yet further aspect of the present invention there is provided a method of designing a pipe support according to the present invention as described or claimed herein. The method may comprise a step of determining a force (e.g. setting a force or calculating a force) that is then used in the method of designing the pipe support. The force may for example relate to a desired retaining force on the pipe, a desired clamping force on the pipe and/or a maximum longitudinal force that the pipe can sustain. The method may comprise a step of adjusting a dimension of a region in the pipe support (adjusting the design or physically adjusting an actual pipe support) so that when the pipe support is installed, it provides a clamping force on the pipe at operational temperatures of a magnitude that depends on the determined force, for example the clamping force may be high enough at cryogenic temperatures to constrain the longitudinal movement of the pipe so that above a threshold force relative movement is permitted. At longitudinal forces below the threshold force, the frictional force exerted on the pipe by the pipe support may be sufficient to prevent relative movement between the pipe and the pipe support.

In certain embodiments, there may be a step of adjusting a dimension of a region in the design of a pipe support to vary a threshold force so that when the pipe support is installed, it provides a clamping force on the pipe at operational temperatures which permits movement between the pipe support and the pipe for forces greater than a threshold force, whilst preventing or restricting movement between the pipe support and the pipe for forces lower than the threshold force.

The step of adjusting the dimension may be done prior to manufacture. This may assist with mass production of correctly adjusted pipe supports. In embodiments, the step may include adjusting the size (and/or shape) of a split in the pipe support as defined in a design file. The method may further comprise a step of adjusting a hole in a structural support so that it corresponds to the redesigned pipe support.

The method may further comprise a step of manufacturing the at least two pipe supports. This may comprise injection moulding at least two pipe supports. The method may comprise a series of tests on the pipe support to ensure that the desired force is applied in cryogenic conditions. These tests may comprise measuring (directly or indirectly) the compressive and/or frictional forces imposed on the pipe by the pipe support at cryogenic and/or ambient pipe temperatures, and/or temperatures between ambient and cryogenic. The tests may involve testing whether the pipe support bottoms out, that is whether the region closes fully as the pipe contracts. In certain embodiments this may be undesirable. An iterative process may be employed to redesign the pipe support, for example the region size in each pipe support, dependant on the outcome of the tests. Data obtained during the tests may be used when determining the required region size for another pipe support. Data obtained during the tests may be used when designing a pipe support for a different application, such as a different sized pipe or different desired retaining force.

The method may further comprise the step of installing the at least two pipe supports on a pipe.

It will be appreciated that the threshold force used in the design process may not be identical to the force above which, in practice, all relative movement between the pipe support and the pipe is permitted and below which no relative movement is permitted, particularly as in practice the precise threshold force at which movement is first permitted (in the case of an increasing force) may not be uniquely defined in practice and may vary, for example on local temperature. However it may be that movement between the pipe support and the pipe is permitted for all forces greater than the threshold force, but not necessarily prevented for all forces lower than the threshold force. For example, there may not need to be any guarantee of preventing movement when the force is at 95% of the threshold force, but movement could nevertheless usefully be restricted when the force is at only 5% of the threshold force.

According to yet another aspect of the present invention, there is provided a fuel tank structure incorporating cryogenic pipework and a pipe support assembly.

According to yet another aspect of the present invention, there is provided an aircraft incorporating a pipe support according to any aspect of the invention as described or claimed herein. The aircraft may be a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and optionally more than 75 passengers. The aircraft may be a commercial aircraft, for example a commercial passenger aircraft, for example a single aisle or twin aisle aircraft. The aircraft need not be configured for carrying passengers, but could for example be an aircraft of an equivalent size configured for cargo and/or used on a non-commercial basis. The aircraft may have a maximum take-off weight (MTOW) of at least 20 tonnes, optionally at least 40 tonnes, and possibly 50 tonnes or more. The aircraft may have an operating empty weight of at least 20 tonnes, optionally at least 30 tonnes, and possibly about 40 tonnes or more.

According to yet another aspect of the present invention there is provided a pipe support for supporting a pipe consisting of two identical pipe supports. Each pipe support comprises an opening configured such that in use the pipe supports are arranged longitudinally along the pipe which is accommodated within the openings. The pipe supports are configured to interlock with each other to constrain movement of the pipe in all radial directions. The pipe supports of this aspect may be orientated inversely to the other, as mentioned above. A pipe support of this aspect may have a plurality of male and female locking portions configured to interlock with corresponding male and female portions of another pipe support.

According to another aspect of the present invention, there is provided a (e.g. single) pipe support configured for use as one of the pipe supports of the pipe support according to any aspect of the invention as described or claimed herein.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a perspective view of a hydrogen-powered aircraft according to a first embodiment of the invention;

FIG. 2 shows a view of a pipe passing through a hole in a structural component of a fuel tank without implementation of the present invention;

FIG. 3 shows a locked cryogenic pipe support in position on the pipe of FIG. 1 according to a first embodiment of the present invention;

FIG. 4 shows a perspective view of a cryogenic pipe support according to the first embodiment;

FIG. 5 shows a perspective view of a cryogenic pipe support according to the first embodiment;

FIG. 6 shows an orthographic rear view of a cryogenic pipe support according to the first embodiment;

FIG. 7 shows an orthographic front view of a cryogenic pipe support according to the first embodiment;

FIG. 8 shows a perspective view of a cryogenic pipe support on a pipe, located against a structural component of a tank according to the first embodiment;

FIG. 9 shows a perspective view of a locked cryogenic pipe support assembly in place on a pipe according to the first embodiment;

FIG. 10 shows a flow diagram illustrating a method of manufacturing a cryogenic pipe support assembly according to a second embodiment of the present invention; and

FIG. 11 shows a flow diagram illustrating a method of installing a cryogenic pipe support assembly according to a third embodiment of the present invention.

### DETAILED DESCRIPTION

Embodiments of the present invention relate to a pipe support assembly suitable for supporting a pipe in cryogenic applications. In use of the embodiments, two separate pipe supports mounted on a pipe are interlocked, and located against a piece of fuel tank structure. The interlocked pipe supports provide a clamping force on the pipe across its thermal expansion/contraction envelope, and therefore a retaining force on the pipe, that can be specified and adjusted for in the design of the pipe support assembly for a particular pipe. This allows for controlled movement of the pipe, preventing damage to the pipe and surrounding structure.

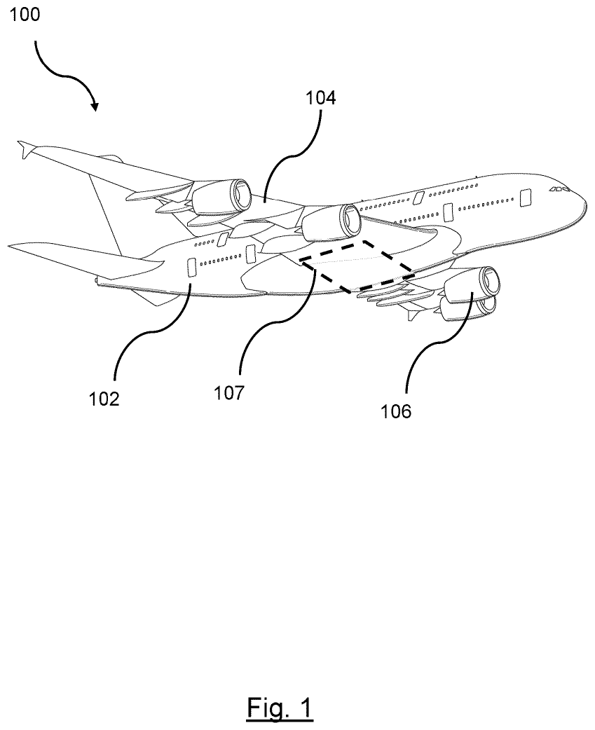

FIG. 1 shows a hydrogen-powered aircraft 100 comprising a fuselage 102, wings 104, and engines 106. A hydrogen fuel tank (schematically represented by box 107 in FIG. 1) stores liquid hydrogen for use as fuel for the engines 106.

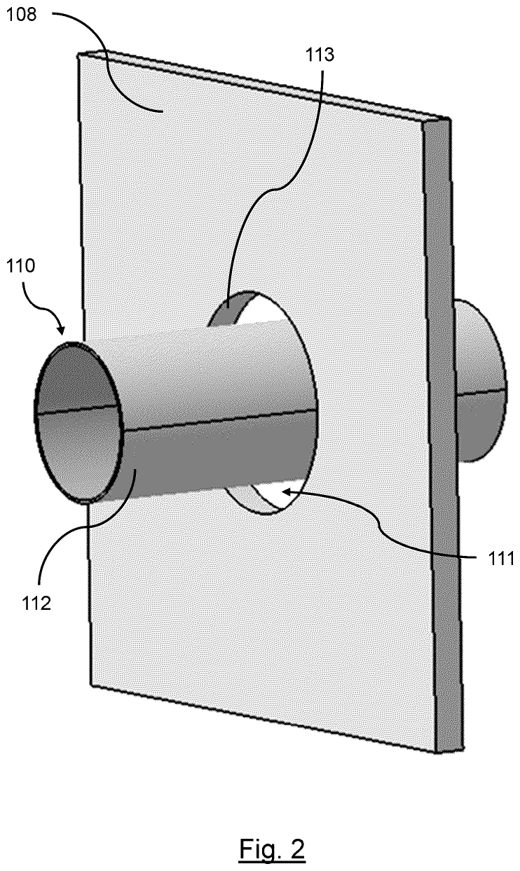

FIG. 2 shows a pipe support of supporting structure 108, e.g., wall, defining or included in a fuel tank, e.g. hydrogen fuel tank 107, on the aircraft 100. A pipe 110, used for transporting liquid hydrogen, passes through a hole 111 in this structure 108. The pipe has an outer surface 112 with a cross-sectional diameter of about 50 mm. As can be seen, the hole 111 is larger than the outer diameter of the pipe 110 such that there is room for a pipe support. The hole 111 is defined by an inside surface 113.

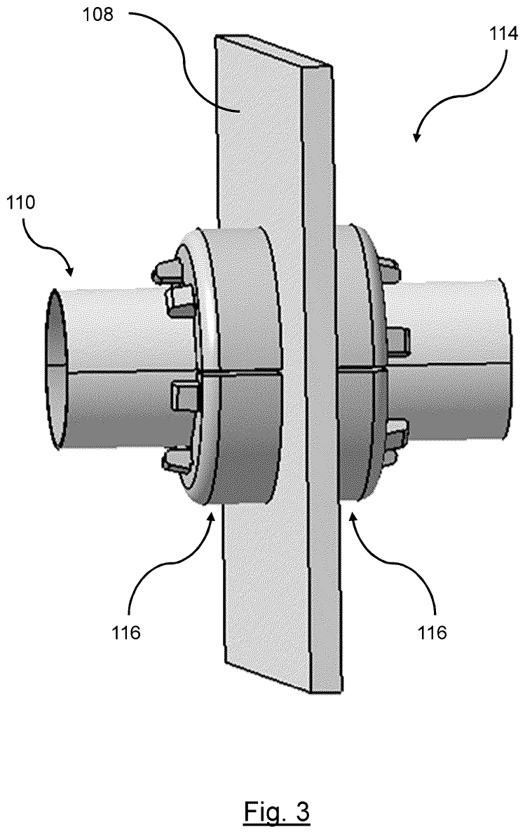

FIG. 3 shows a pipe support 114 of the present invention in use in relation to the pipe 110 and support structure 108 of FIG. 2. As can be seen, the pipe support 114 is made up of two identical pipe supports 116, which are interlocked with each other. This will be further detailed later. The structure of each pipe support 116 will now be described.

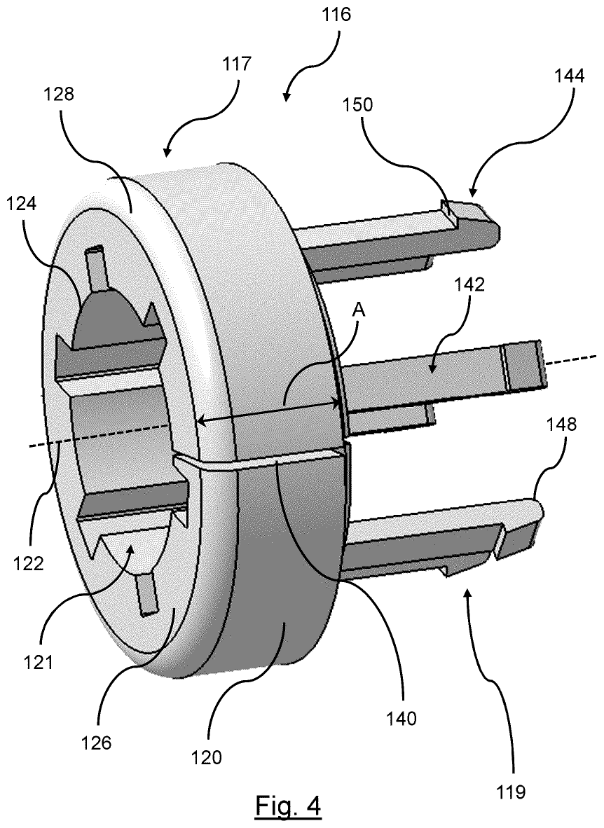

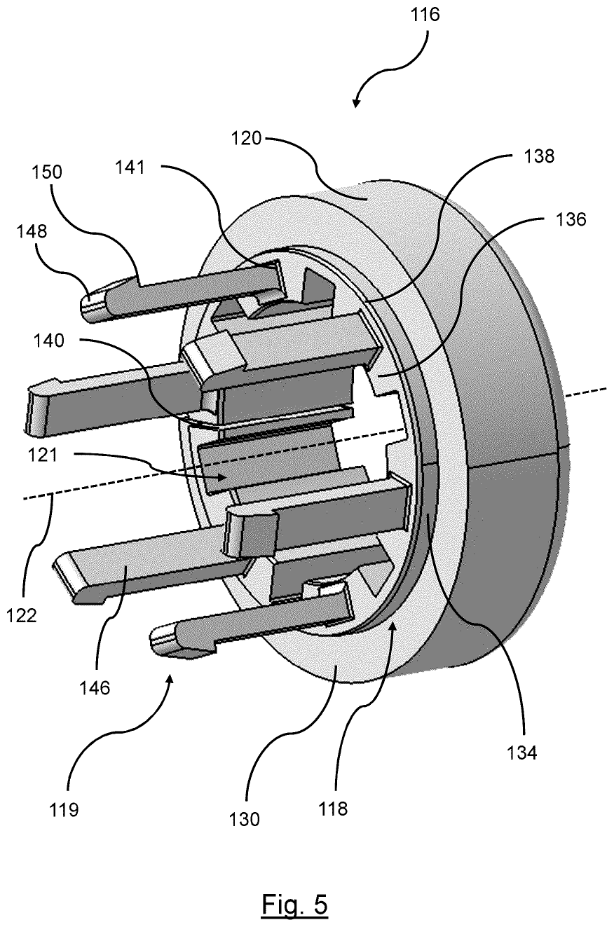

Referring now to FIGS. 4 and 5, perspective views of a pipe support 116 are shown. The pipe support 116 is made up of a body 117, a locating spigot 118, and multiple teeth 119. The pipe support 116 is made out of a suitable polymer, in this case a polymer of PCTFE.

The body 117 is generally cylindrical and comprises an outer surface 120 and an inner surface 121. The outer surface 120 is a cylindrical surface having a length shown by arrow A. The outer surface 120 has a circular cross-section centred on the axis 122, the cross section being constant for the majority of the surface's length. The inner surface 121 is defined by a line 124 of cross section, which line is constant in the direction of the axis 122.

The inner surface 121 and outer surface 120 terminate at one end, ends being defined in this case along the longitudinal axis 122, in a rear surface 126 extending in perpendicular directions to the axis 122. The vertex between the outer surface 120 and rear surface 126 is filleted 128 (and thus the outer surface 120 does not have a constant circular cross section for its entirety). The outer surface 120 terminates at the other end in a first front surface 130, perpendicular to the axis 122.

Extending from the first front surface 130 along the axis 122 is the locating spigot 118. The locating spigot 118 is defined by the inner surface 121, and a locating spigot outer surface 134. The locating spigot outer surface 134 has a circular cross section centred on the axis 122, the cross section being constant for the majority of the surface's length. The diameter of the circular cross section of the locating spigot outer surface 134 is less than the diameter of the circular cross section of the outer surface 120 (not including the fillet 128). The locating spigot 118 terminates at an end opposite the first front surface 130 in a locating spigot front surface 136, perpendicular to the axis 122. The vertex between the locating spigot outer surface 134 and the locating spigot front surface 136 is chamfered 138 (and thus the locating spigot outer surface 134 does not have a constant circular cross section for its entirety).

A split 140, most visible in FIG. 4, is present on the pipe support body 117 and locating spigot 118. The split 140 runs from the rear surface 126 to the locating spigot front surface 136. The split 140 extends from the inner surface 121 to the outer surface 120 and locating spigot outer surface 134. Effectively, this means that the cross sections of the inner surface 121, outer surface 120, and locating spigot outer surface 134, are open shapes, and are in the form of split rings. The split 140 is 1° thick, measured about the axis 122.

FIGS. 4 and 5 also show six identical teeth 119 extending out from the locating spigot front surface 136. The bases 141 of the teeth 119 are uniformly arranged in a circular pattern about axis 122. The teeth 119 have a consistent orientation with respect to the axis 122—i.e. the inner face 146 of each tooth is always directed towards the central axis 122. The teeth 119 extend along the longitudinal axis 122. The teeth 119 are integrated parts of the pipe support 116, i.e. not external fixings.

The head 144 of each tooth 119 is disposed at the end of each tooth body 142 furthest from each base 141, each comprising a curved front surface 148. Each head also comprises a ridge 150 which extends on the outside face (outside defined relative to the axis 122) of each tooth 119 in a direction substantially perpendicular to each tooth body 142, across the width of each tooth body 142.

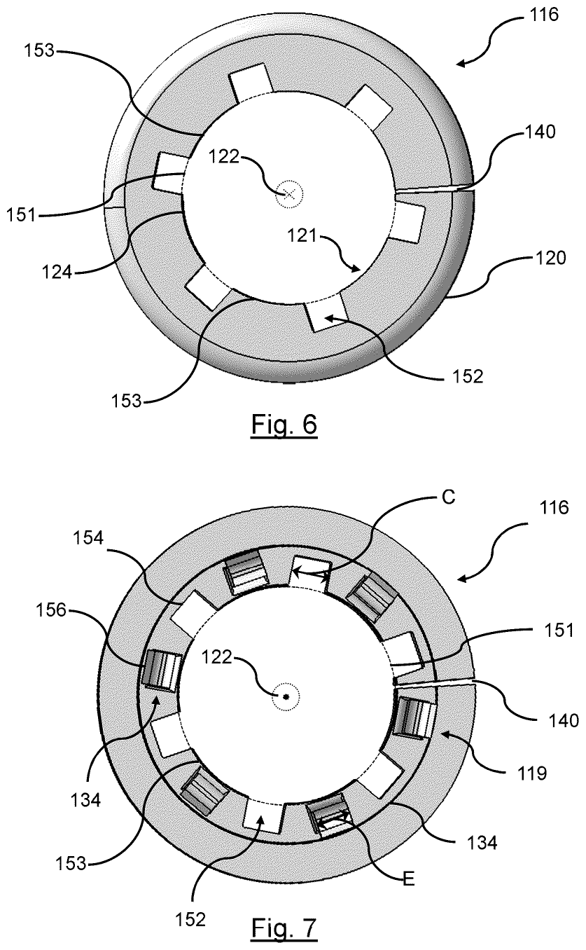

FIGS. 6 and 7 show rear and front views of the first pipe support 116 respectively. For clarity, only relevant items will be relabelled.

As can be seen, the split 140 extends from the inner surface 121 to the outer surface 120 with a constant angular thickness. Note that the cross section of the split 140 when viewed down the axis 122 is constant.

The internal cross section line 124 defining the inner surface 121 will now be detailed. The internal cross section line 124 is a broken circle centred on axis 122. The circle without breaks is shown by illustrative dashed line 151. The circle is broken by six identical rectangular indents 152 arranged uniformly around the circle. The rectangular indents 152 are configured to receive the teeth 119 of the second pipe support structure 116 opposite to the first pipe support. These indents 152 extend in a direction perpendicular to and away from the axis 122. The indents 152 do not extend to the locating spigot outer surface 134. In this way, the inner surface 121 of the pipe support 116 is made up of 6 arc sections 153 and 6 rectangular indents 152, arranged in an alternating pattern around the central axis 122. The width of the indents 152, indicated by double-headed arrow C, is larger than the width of the body of the teeth 119, indicated by double-headed arrow E. The split 140 in the internal cross section 124 is located through an arc section 153 of the internal cross section 124, not an indent 152.

In FIG. 7 it can be seen that the outermost edges 156 of the ridges 150 are disposed further from the axis 122 in a perpendicular direction than the indent walls 154. Additionally, it can be seen that the teeth 119 in FIG. 7 line up with the indents 152 in FIG. 6 in relation to angular and radial position about the axis 122. The purpose of this will be displayed in the next set of images, which display the invention according to the first embodiment in use.

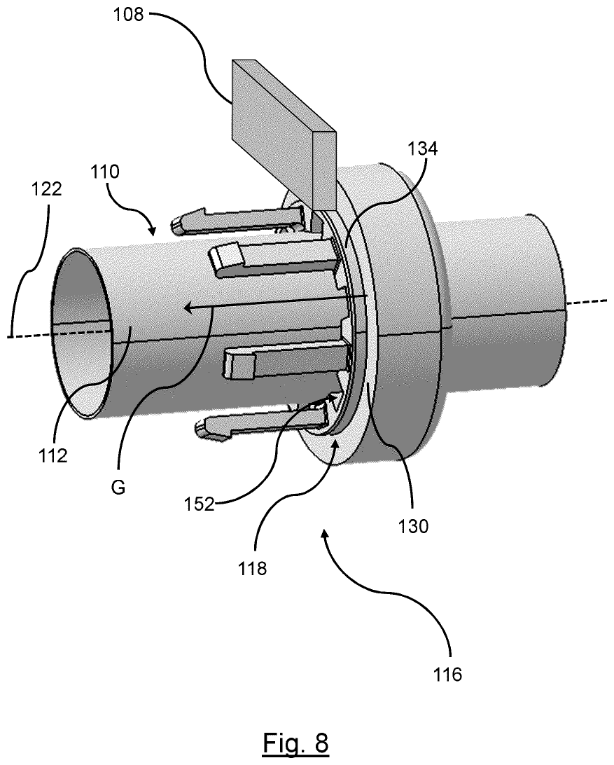

FIG. 8 shows a pipe support 116 positioned on a pipe 110 located against a piece of tank support structure 108. For clarity, only a section of the tank support structure 108 is shown, but it will be appreciated that it extends in the same way as shown in FIG. 2. The tank support structure 108 can be considered to be fixed in place relative to the aircraft 100 (not pictured). As can be seen, the locating spigot 118 fits into the hole 111 (visible in FIG. 2) such that the locating spigot outer surface 134 is flush with a portion of the hole inside surface 113 (visible in FIG. 2), and the first front surface 130 is flush with the wall of the tank support structure 108. This means that the pipe support 116 is unable to move further in the direction of arrow G, as it is blocked by the tank support structure 108.

The pipe 110 is disposed through the pipe support 116 such that the pipe outer surface 112 is flush with the arc sections 153 (not clearly visible in FIG. 8) of the inner surface 121 (not clearly visible in FIG. 8). The indents 152 of the pipe support inner surface therefore form six gaps between the pipe outer surface 112 and the pipe support inner surface 121. Flushness is ensured by the split (not visible) allowing for a changing dimension of the pipe support.

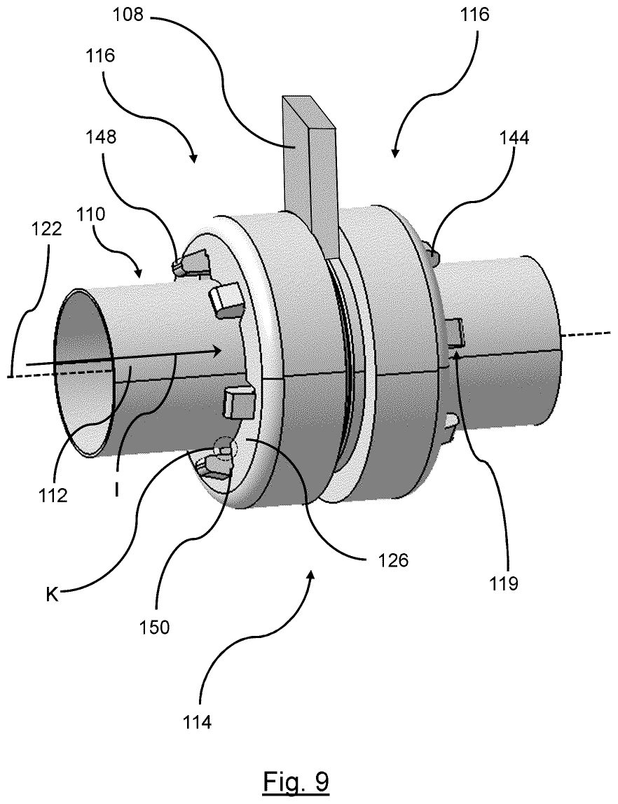

FIG. 9 shows first and second pipe supports 116 interlinked to form a pipe support 114 in use. For the purposes of clarity, pipe support 116 in FIG. 8 will be referred to as the ‘first pipe support’, and the pipe support 116 added in FIG. 9 will be referred to as the ‘second pipe support’. The second pipe support is identical to the first pipe support, but is just placed on the pipe 110 with its orientation in a lateral or vertical axis reversed. The components of the second pipe support will be referenced with identical reference numerals to the first pipe support detailed above.

In the same way as in FIG. 8, the outer surface 112 of the pipe 110 is flush with the arc sections 153 (not clearly visible in FIG. 9) of the second pipe support inner surface 121 (not clearly visible in FIG. 9), and six gaps are formed by the indents 152 (not clearly visible in FIG. 9). In FIG. 9, the second pipe support has been pushed onto the pipe 110 in the direction indicated by arrow I. The second pipe support locates against the tank support structure 108 (again illustrated in sectional view) in the same way as the first pipe support, just from the opposite direction. As the second pipe support moves in the direction of arrow I, the teeth 119 (only the teeth heads 144 visible) of the second pipe support pass through the gaps formed by the indents 152 of the first pipe support, and vice versa (the teeth having a clearance fit within the gaps with respect to width). The curved front surface 148 of the teeth 119 assist in allowing the teeth to pass through the gaps. It will be appreciated that given that the ridges 150 of the teeth 119 are disposed further from the axis 122 than the outer walls 154 (not clearly visible in FIG. 9) of the indents 152 (as detailed in reference to FIG. 7), the teeth will elastically deform inwardly towards the axis 122 during passage through their respective gaps. As the second pipe support is pushed so that it is located against the tank support structure 108, the ridges 150 of the teeth 119 of the second pipe support will exit at the rear surface 126 of the first pipe support, and vice versa. The teeth ridges 150, no longer constrained by the walls 154 of the indents 152, will elastically undeform back to their normal disposition. The ridges 150 therefore overhang the indents 152 at the rear surface 126, preventing return motion (the positioning of ridges 150 and indents 152 being detailed in respect to FIG. 7). In this way, the two pipe supports 116 are locked in position relative to each other. As they are both flush with the tank support structure 108, they are also effectively fixed in longitudinal position relative to the tank support structure 108. In this position, the locating spigot of the second pipe support is also disposed in the hole in the tank support structure 108 in the same way as the locating spigot of the first pipe support.

The pipe 110 is supported by the arc sections 153 of the inner surfaces 121 of the pipe support 114. However, there is no physical interference to prevent the pipe 110 moving along the axis 122. Friction between the arc sections 153 and the pipe outer surface 112 is the only retaining force for said movement of the pipe 110. It will be appreciated that a change in thickness of the split 140 (not visible) will alter the compressive force that the pipe support 114 exerts on the pipe 110, and therefore the magnitude of the retaining frictional force. Therefore, a designer of the pipe support 114 can customise the retaining force by altering the size/geometry of the split 140 depending on the application. Should the pipe exert a force in a longitudinal direction greater than the retaining force, for example in this case a force of 100N, movement is permitted by the pipe support 114.

It will additionally be appreciated that the split 140 allows for a change in size of the volume defined by the inner surface 121. Upon thermal contraction of the pipe 110 due to passing of cryogenic fluid through said pipe, the pipe support 114 can reduce in size at the same rate, and therefore keep the arc sections 153 flush with the pipe surface 112 and providing a reliable force on the pipe 110. Without this, differences in thermal contraction/expansion could cause issues. For example, if the pipe 110 contracts faster than the pipe support 114, the pipe could become loose and unsupported. If the pipe 110 contracts more slowly than the pipe support 114, the pipe may be squeezed and possibly damaged by the pipe support 114, and be unable to move when needed owing to a higher force between the two items. With the embodiment as described, the relative changes in size between the two items, and thus the clamping force exerted between the two, are more consistent as cryogenic fluid is passed through the pipe. Therefore, undesired movement of the pipe support can be eliminated, and desired movement can be better realised, as these are controlled by the force between the pipe 110 and the pipe support 114.

Therefore, a pipe support 114 is disclosed which does not rely on welds or fasteners, which can permit selected motion of the pipe in regards to a pre-determined threshold, and which is suitable for cryogenic applications.

It will be seen in FIG. 9 in the dashed circle labelled K, that when the teeth 119 are disposed against the rear surface 126 of the pipe supports 116, a small gap is still present (which the ends of the teeth 119 elastically deform into during passage through their respective gaps). These gaps permit detachment of the pipe supports from each other, if all ridges 150 are pressed inwardly towards the axis 122 concurrently, and the pipe supports pulled away from each other concurrently in opposite longitudinal directions.

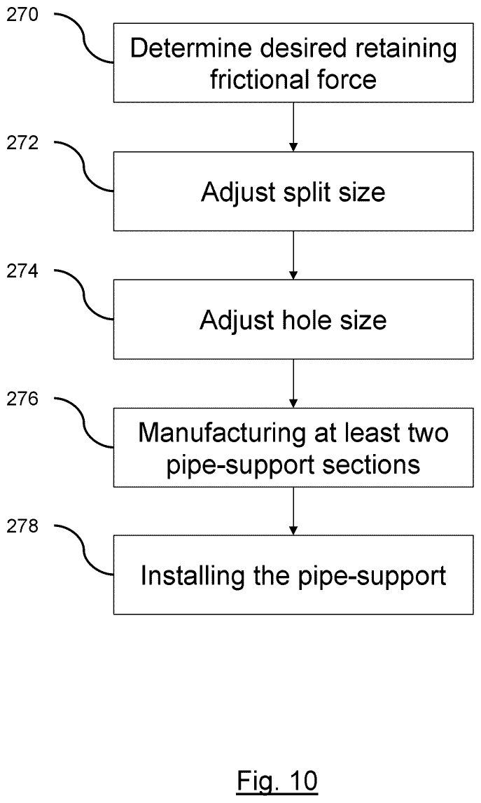

FIG. 10 shows a flow diagram illustrating a method according to a second embodiment of the present invention, which could utilise the apparatus of the first embodiment. The method is performed in respect of a cryogenic pipe support. The method is performed for the purpose of manufacturing a pipe support suitable for cryogenic applications, which allows for controlled movement of the pipe in the longitudinal direction.

The method includes a step of determining 270 a desired retaining frictional force for a pipe in cryogenic conditions. This is the force which the pipe must be exerting on a pipe support in either direction along the longitudinal axis for movement in said either respective direction to be permitted. The method further includes a step of adjusting 272 the size of a split in a pipe support to set the retaining frictional force at the desired level. More specifically, this step includes editing the design of the pipe support before manufacture. The design changes are informed by data obtained from tests carried out on pipe supports previously. The method further comprises a step of adjusting 274 holes in a structural support so that they align with the redesigned pipe support. The method further comprises a step of manufacturing 276 at least two pipe supports with the desired split size. More specifically, this step comprises injection moulding at least two pipe supports. The pipe supports are tested to ensure they perform as expected, for example to ensure they provide the desired frictional force on a pipe in cryogenic conditions. The method further comprises the step of installing 278 the pipe support onto the pipe.

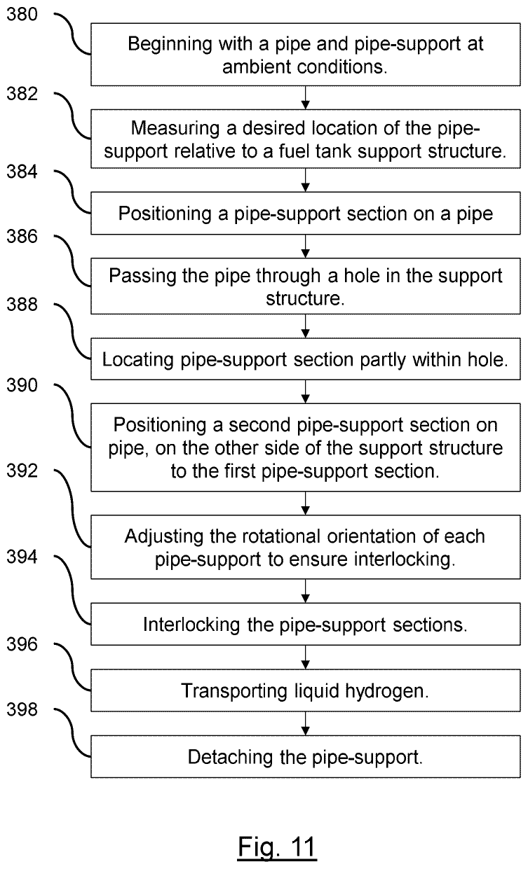

FIG. 11 shows a flow diagram illustrating a method according to a third embodiment of the present invention, which could utilise the apparatus of the first embodiment. The method of the third embodiment could utilise the pipe supports manufactured in step 276 of the method of the second embodiment of the present invention. The method is performed in respect of a cryogenic pipe support. The method is performed for the purpose of installing a pipe support onto a pipe for cryogenic applications.

The method includes the step of beginning 380 with a pipe and pipe support at ambient conditions. The method includes the step of measuring 382 a desired location of the pipe support on the pipe relative to a piece of fuel tank support structure.

The method further includes the step of positioning 384 a pipe support on the pipe. This includes pushing the pipe support onto the pipe from one longitudinal end of the pipe. This further includes orienting the pipe support so that teeth of the pipe support are pushed forward onto the pipe, i.e. the teeth lead a body of the pipe support. This step further includes pushing the pipe support onto the pipe until the pipe support reaches the desired location.

The method further includes the step of passing 386 the pipe, with the single pipe support positioned about it, through a hole in the fuel tank support structure. This step further comprises passing the pipe through so that the teeth of the pipe support are moving forwards, i.e. towards the fuel tank support structure ahead of the rest of the pipe support.

The method further comprises the step of locating 388 the pipe support at least partly within the hole in the fuel tank support structure. This step includes aligning a locating spigot on the pipe support within the hole in the fuel tank support structure.

The method further comprises the step of positioning 390 a second pipe support on the pipe on the other side of the fuel tank support structure to the first pipe support. More specifically, this step comprises orienting the second pipe support so that the teeth lead the body in the direction of travel. This includes orientating the second pipe support 180 degrees relative to an axis perpendicular to the longitudinal axis of the pipe, relative to the first pipe support. This further includes pushing the second pipe support on the pipe until the teeth of the second pipe support are adjacent to the teeth of the first pipe support.

The method further comprises a step of adjusting 392 the orientation of the two pipe supports so that the teeth of each pipe support align with teeth-receiving gaps in the other pipe support. This orientation is about the longitudinal axis of the pipe, and prepares the pipe support to interlock.

The method further comprises a step of interlocking 394 the two pipe supports to form a pipe support assembly. This comprises bracing the first pipe support and pushing the second pipe support towards it such that the teeth of each pipe support pass through the gaps of the other pipe support, and a ridge at the end of each tooth abuts the rear surface of the each other pipe support, securing the two pipe supports relative to each other and the fuel tank support structure. This also locates the second pipe support to the tank support structure in the same way the first pipe support was located.

The method further comprises the step of transporting 396 liquid hydrogen through the pipe, for example to or from a fuel tank, for example of a hydrogen powered vehicle, such as for example an aircraft. This step further comprises the pipe cooling to a temperature of 20K when liquid hydrogen passes through it. This step further comprises allowing the pipe to move in a longitudinal direction relative to the pipe support when the pipe exerts a force greater than a preset threshold force (e.g. of at least 60N) in said longitudinal direction, due to thermal contraction of the pipe during cooling. This step further comprises, after hydrogen has been passed through the pipe for a certain operation, the pipe returning to ambient temperatures. The step further comprises allowing the pipe to move in a longitudinal direction relative to the pipe support when the pipe exerts a force of at least 60N in said longitudinal direction, due to thermal expansion of the pipe as it warms.

The method further comprises the step of, when the pipe support needs to be removed for inspection, maintenance, retirement, or other reason, detaching 398 the pipe support. This step further comprises allowing the apparatus to return to ambient temperatures before detaching 398. The step further comprises using a tool to compress the teeth of each pipe support towards the longitudinal axis of the pipe, and pulling the first and second pipe supports apart.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The integrated teeth that perform the function of male and female locking portions may take other forms, for example anchoring fixings which contract to pass through a hole and splay on the other side to prevent return movement. The exact form of the male and female locking portions is not important, but their design should be such that there is an acceptably low risk of them breaking at low temperatures.

The pipe support described herein would be perfectly suitable for non-cryogenic applications. Use of the pipe support on pipes transporting traditional fuels such as kerosene is foreseeable. The pipe support may still provide benefits such as reduced manufacturing and installation time compared to welding, as well as easier purposeful disassembly.

The pipe support changes its dimension using a split through its radial thickness. This split does not necessarily need to be all the way through the radial thickness to still provide the benefit of a changeable inner surface diameter. Further, any suitable means of creating a changeable inner surface diameter could be applicable.

Further, the pipe support may be applicable to other sizes and shapes of pipe, as long as the pipe support still constrains the pipe in all radial directions, can provide the desired threshold force, and can change size to cope with thermal expansion/contraction.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A pipe support assembly configured to support a pipe extending through an opening in a pipe support structure in a cryogenic application, wherein the pipe support comprises:
a first pipe support and a second pipe support each including an annular body and teeth extending longitudinally from the annular body, wherein the annular body includes an inside surface configured to be adjacent an outer surface of the pipe and indents in the inside surface extending longitudinally through the inside surface from a front face of the annular body to a rear face of the annular body;
wherein the indents of the first pipe support are arranged to receive the teeth of the second pipe support, and the indents of the second pipe support are arranged to receive the teeth of the first pipe support; and
wherein the first and second pipe supports have substantially the same shape and dimensions.

2. The pipe support assembly of claim 1, wherein the teeth each includes a distal region with a head forming a ridge extending radially outward.

3. The pipe support assembly of claim 1, wherein the teeth of each on the first pipe support and the second pipe support are arranged in a circular array around a longitudinal axis of the respective first or second pipe support.

4. The pipe support assembly of claim 1, wherein the first pipe support and the second pipe support are each formed of a polymer including at least one of thermoplastic poly(haloethylene), poly(tetrahaloethylene), poly(chlorotrifluoroethylene), poly ether ether ketone, poly ether ketone ketone or polychlorotrifluoroethylene.

5. The pipe support assembly of claim 1, wherein the first pipe support and the second pipe support each include a split extending longitudinally through the annular body from the front face to the rear face and extending from an outer annular surface of the annular body to the inside surface of the annular body.

6. The pipe support assembly of claim 1, wherein the teeth in the first pipe support is at least six teeth and the second pipe support has the same number of the teeth as does the first pipe support.

7. The pipe support assembly of claim 1, wherein the first pipe support and the second pipe support share a common lateral axis the teeth of the first pipe support and the teeth of the first pipe support and the second pipe support are parallel to the common lateral axis.

8. The pipe support assembly of claim 1, wherein each of the first pipe support and the second pipe support include an annular spigot on the front face, wherein the spigot has an outer diameter configured to fit into the opening of the pipe support structure.

9. The pipe support assembly of claim 8, wherein the annular spigot includes a front surface integral with a distal end of each of the teeth for the respective one of the first pipe support or the second pipe support.

10. The pipe support assembly of claim 1, wherein each of the teeth has a length sufficient to extend through one of the first pipe support or the second pipe support and through the opening in the pipe support structure.

11. An assembly configured for a cryogenic fuel tank in an aircraft, the assembly comprising:
a pipe configured to transport a cryogenic fuel to or from the cryogenic fuel tank;
a pipe support structure associated with the cryogenic fuel tank, wherein the pipe support structure includes an opening through which extends the pipe;
a pipe support assembly forming a collar around the pipe at the opening and securing the pipe to the pipe support structure;
wherein the pipe support assembly includes:
a first pipe support on a first side of the pipe support and a second pipe support on a second side, opposite to the first side, of the pipe support;
wherein the first pipe support and the second pipe support each include an annular body and teeth extending longitudinally from the annular body, wherein the annular body includes an inside surface adjacent an outer surface of the pipe and indents in the inside surface extending longitudinally through the inside surface from a front face of the annular body to a rear face of the annular body;
wherein the indents of the first pipe support receive the teeth of the second pipe support, and the indents of the second pipe support receive the teeth of the first pipe support; and
wherein the first and second pipe supports have substantially the same shape and dimensions.

12. The assembly of claim 11, wherein the teeth each includes a distal region with a head forming a ridge extending radially outward.

13. The assembly of claim 11, wherein the teeth of each on the first pipe support and the second pipe support are arranged in a circular array around a longitudinal axis of the respective first or second pipe support.

14. The assembly of claim 11, wherein the first pipe support and the second pipe support are each formed of a polymer including at least one of thermoplastic poly(haloethylene), poly(tetrahaloethylene), poly(chlorotrifluoroethylene), poly ether ether ketone, poly ether ketone ketone or polychlorotrifluoroethylene.

15. The assembly of claim 11, wherein the first pipe support and the second pipe support each include a split extending longitudinally through the annular body from the front face to the rear face and extending from an outer annular surface of the annular body to the inside surface of the annular body.

16. The assembly of claim 11, wherein the teeth in the first pipe support is at least six teeth and the second pipe support has the same number of the teeth as does the first pipe support.

17. The assembly of claim 11, wherein the first pipe support and the second pipe support share a common lateral axis the teeth of the first pipe support and the teeth of the first pipe support and the second pipe support are parallel to the common lateral axis.

18. The assembly of claim 11, wherein each of the first pipe support and the second pipe support include an annular spigot on the front face, wherein the spigot has an outer diameter configured to fit into the opening of the pipe support structure.

19. The assembly of claim 18, wherein the annular spigot includes a front surface integral with a distal end of each of the teeth for the respective one of the first pipe support or the second pipe support.

20. The assembly of claim 11, wherein each of the teeth has a length sufficient to extend through one of the first pipe support or the second pipe support and through the opening in the pipe support structure.
